(19) United States
(12) Patent Application Publication
(10) Pub. No.: US 2007/0000766 A1
(43) Pub. Date: Jan. 4, 2007

(54) Keypad, manufacturing method thereof and electronic device using the same

(75) Inventors: Qing Yang, Shenzhen (CN); Chia-Hua Chen, Tu-cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO.,LTD, Shindian City (TW)

(21) Appl. No.: 11/442,073

(22) Filed: May 26, 2006

(30) Foreign Application Priority Data
Jul. 1, 2005 (CN) 200510035748.6

(51) Int. Cl. H01H 13/14

(52) U.S. Cl. 200/341

(57) ABSTRACT

A keypad (20) includes a plurality of keytops (22) and an elastic base (24). The keytops are integrally formed at one side of the elastic base. A manufacturing method of the keypad (20) is provided. An electronic device (30) employing the keypad is also provided. The keypad has good adhesion between the keytops and the elastic base, which can prevent separation between the keytop and the elastic base.

### TECHINICAL FIELD

The present invention generally relates to keypads, and particularly to, an integrally formed keypad, a manufacturing method thereof and an electronic device using the same.

### BACKGROUND

Nowadays, electronic devices such as mobile phones are widely used and bring convenience to our lives. Electronic devices have become a part of modern life.

A keypad is a main component of an electronic device, and widely used in phones, counters, and computers. A typical keypad is disclosed in FIG. 5. The keypad includes a hard keytop 10 and a soft rubber base 12. The keytop 10 is formed on the rubber base 12 in such a manner that the keypad can return to its original state due to the elasticity of the rubber base 12.

A manufacturing method of the typical keypad includes the following steps of: injecting plastic material such as polycarbonate, polymethyl methacrylate (PMMA), polystyrene into a mold to form the hard keytop 10; forming the rubber base 12 via a rubber compression mold; and joining the keytop 10 and the rubber base 12 together with an adhesive.

During using process of the keypad, the keytop has a tendency to release from the rubber base 12, which results in a malfunction of the keypad, working life time of the keypad is therefore short. In addition, because the keytop 10 and the rubber base 12 are separately formed, it is required to separate design molds for each part. Furthermore, other manufacturing processes are required to join the keytop 10 and the rubber base 12 together. That is, the manufacturing method of the keypad is complicated and requires many molds and jigs, which increases manufacturing cost.

What is needed, therefore, is a keypad and a manufacturing method thereof which overcomes above-described problems.

### SUMMARY OF THE INVENTION

In one aspect, a keypad is provided. The keypad comprises a plurality of keytops and an elastic base. The elastic base is integrally formed with the keytops. The keytops are formed at one side of the elastic base.

In another aspect, a manufacturing method of a keypad is provided. The manufacturing method comprises the following steps of: preparing a first mold and a second mold; forming a plurality keytops in the first mold, with a plurality of connecting members formed around each keytop connecting the keytops together; transferring the keytops with the connecting members into the second mold, forming an elastic base in the second mold, with the keytops and the connecting member integrally formed at one side of the elastic base; removing the elastic base together with the keytops, and the connecting members from the second mold; and trimming the connecting members from the keytops to form an integral keypad.

Other advantages and novel features of the preferred embodiments of the present keypad and its applications will become more apparent from the following detailed description when taken in conjunction with the accompanying drawings.

### BRIEF DESCRIPTION OF THE DRAWINGS

Many aspects of the present keypads and their applications can be better understood with reference to the following drawings. The components in the drawings are not necessarily drawn to scale, the emphasis instead being placed upon clearly illustrating the principles of the keypads. Moreover, in the drawings, like reference numerals designate corresponding parts throughout the several views.

FIG. 1 is an isometric view of a keypad in accordance with a first preferred embodiment.

FIG. 2 is a schematic view of a keytop of the keypad of FIG. 1.

FIG. 3 is a schematic view of the keytop from FIG. 1 and a base formed together.

FIG. 4 is an isometric view of an electronic device employing the keypad of FIG. 1.

FIG. 5 is an isometric view of a typical keypad.

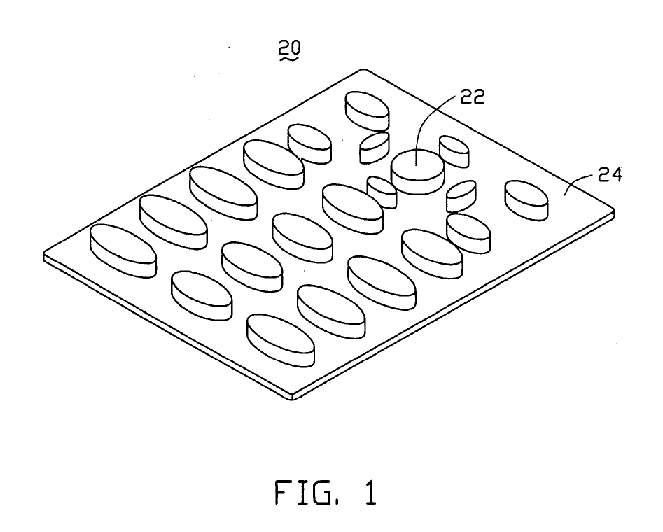

### DETAILED DESCRIPTION OF PREFERRED EMBODIMENTS

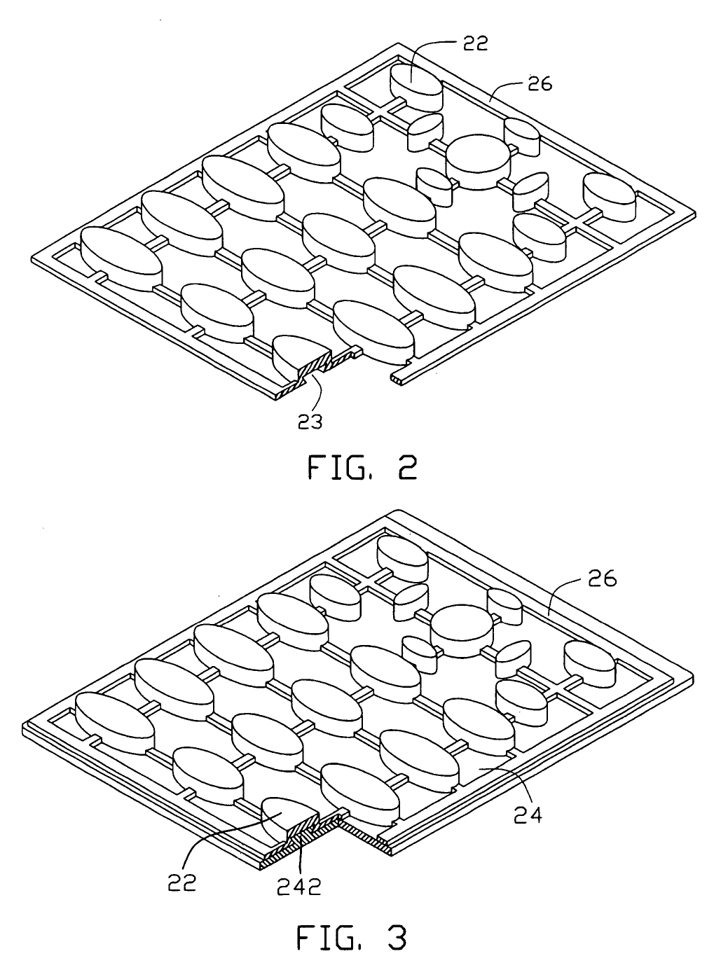

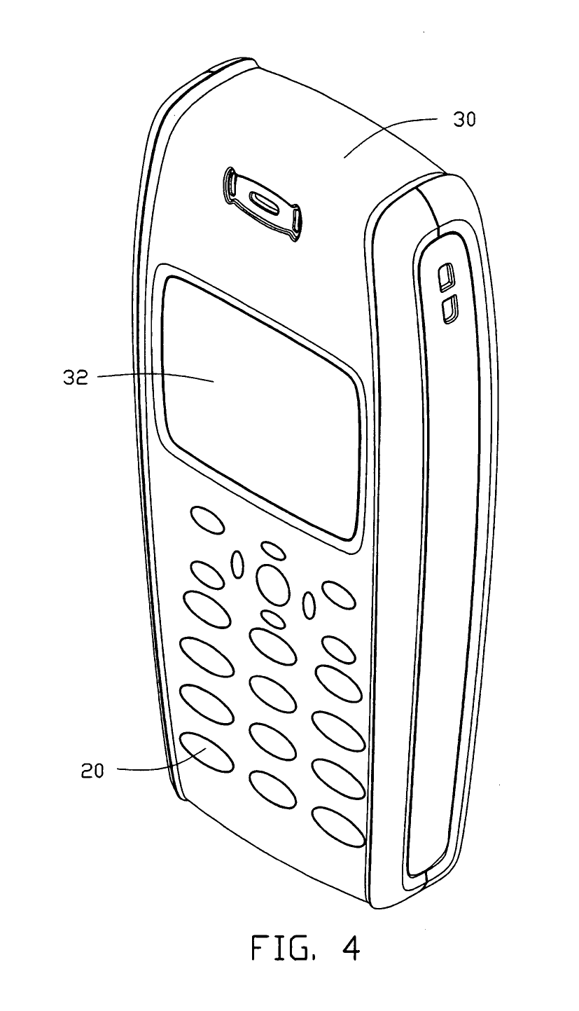

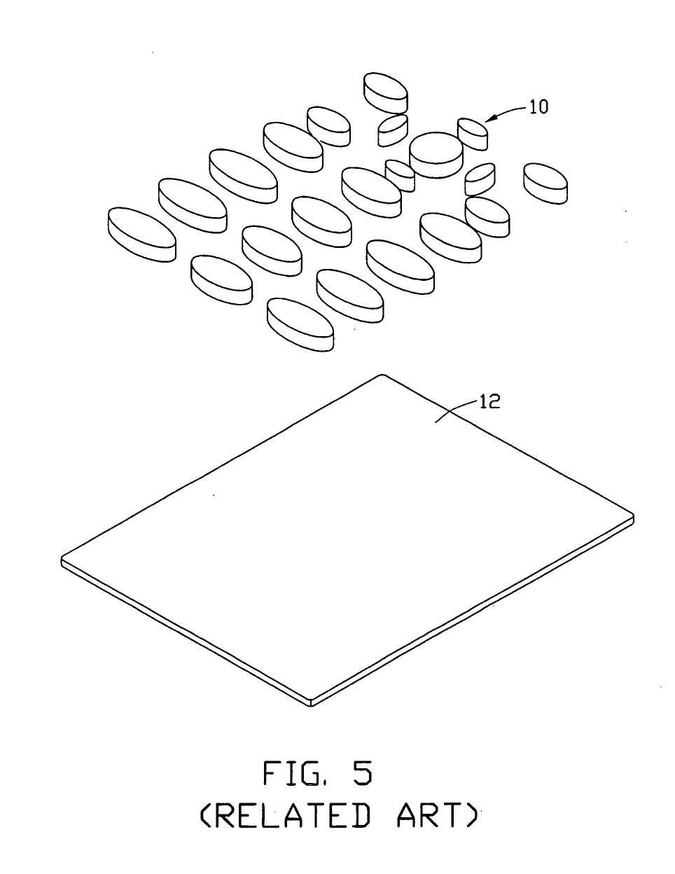

Referring to FIG. 2, a keypad 20 according to a preferred embodiment is shown. The keypad 20 includes a plurality keytops 22 and an elastic base 24.

Referring also to FIG. 3, the keytops 22 are integrally formed at a top side of the elastic base 24. Each keytop 22 has a groove 23 defined in a bottom surface thereof. The elastic base 24 has a plurality of protrusions 242, corresponding to the grooves 23. Each protrusion 242 is received in a respective groove 23 of the keytop 22.

The keytop 22 is preferably made of a plastic material. The plastic material may be polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, or any desired combination thereof. The elastic base 24 is preferably made of an elastic thermoplastic, such as thermoplastic urethanes (TPU).

A method of manufacturing the keypad 20 comprises the steps of:
(1) preparing a first mold and a second mold;
(2) forming the keytops 22 in the first mold, with connecting members 26 formed around each keytop and connecting the keytops together;
(3) transferring the keytops 22 with the connecting members 26 into the second mold;
(4) forming the elastic base 24 in the second mold, with the keytops 22 and the connecting member 26 integrally formed at one side of the elastic base;
(5) removing the elastic base 24 together with the keytops 22, and the connecting members 26 from the second mold; and
(6) trimming the connecting member 26 from the keytops 22 to form the keypad 20.

In the first step, the first mold includes a first male mold, and a first female mold mating with the first male mold. The first female mold has a first gate for feeding molten resin into a first cavity defined by the first male mold and the first female mold. The second mold includes a second male mold, and a second female mold mating with the second male mold. The second female mold includes a second gate for feeding molten elastic thermoplastic. The first male mold and the second male mold are mounted on a rotatable plate in such a manner that the first male mold and the second male mold respectively align with the first female mold and the second female mold.

In the second step, molten thermoplastic material is injected into the first cavity via the first gate to form the keytops 22. The first mold is cooled. After that, the keytops 22 with the grooves 23 are formed, with the keytops 22 and the connecting member 26 adhering to the first male mold. Plastic material remaining in the runners in the first mold forms the connecting members 26 around a periphery of each keytop 22. The connecting members 26 connect all the keytops 22 together.

In the third step, the first mold is opened. The first male mold is rotated to align with the second female mold to form a second cavity, with the keytops 22 and the connecting member 26 being transferred from the first cavity into the second cavity. Simultaneously, the second male mold is rotated to align with the first female mold.

In the fourth step, molten elastic thermoplastic is injected into the second cavity via the second gate to form the elastic base 24, with the keytops 22 and the connecting member 26 integrally formed at one side of the elastic base 24. Also, the molten elastic thermoplastic material fill in the grooves 23 of the keytop 22. Simultaneously, another set of keytops 22 with the groove 23 is formed through the first gate by injecting molten thermoplastic material into a cavity formed by the second male mold and the first female mold.

In the fifth step, the second mold is cooled. The elastic base 24, the keytops 22 and the connecting member 26 are removed from the second mold after the second mold is cooled.

In the sixth step, the connecting members 26 are trimmed from the keytops 22 to form the integral keypad 20.

In an alternative embodiment, a first mold and a second mold are provided. In this case, the first mold includes a male mold, a first female mold. The second mold includes a second female mold. The first mold and the second mold share a same male mold. The male mold is rotatable or movable to selectively align with the first and the second female mold. The first female mold has a first gate for feeding molten resin into a first cavity defined by the male mold and the first female mold. The second female mold includes a second gate for feeding molten elastic thermoplastic into a second cavity defined by the male mold and the second female mold.

Referring to FIG. 5, an electronic device 30 with the keypad 22 includes a body (not labeled). The body has a display 32 and the keypad 22 disposed adjacent the display 32. The electronic device 30 has long work lifetime because of the integrally formed keypad 22.

In a further alternative embodiment, the grooves 23 can be omitted.

The keypad 20 has good adhesion between the keytops 22 and the elastic base 24, which can prevent separation between the keytop 22 and the elastic base 24. The keypad 22 is integrally formed, which reduces manufacturing time and cost.

It is believed that the embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

We claim:

1. A keypad, comprising:
an elastic base; and
a plurality of keytops, the keytops being integrally formed at one side of the elastic base.

2. The keypad as claimed in claim 1, wherein the keytops are made of a material selected from the group consisting of polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, and polypropylene.

3. The keypad as claimed in claim 2, wherein the elastic base is made of thermoplastic urethanes (TPU).

4. The keypad as claimed in claim 2, wherein each keytop has a groove defined in a bottom thereof, the elastic base has a plurality of protrusions formed at one side thereof, each protrusions engages in the respective groove.

5. A method of manufacturing a keypad, comprising the steps of:
preparing a first mold and a second mold;
forming a plurality of keytops in the first mold, with a plurality of connecting members formed around each keytop and connecting the keytops together;
transferring the keytops with the connecting members into the second mold;
forming an elastic base in the second mold, with the keytops and the connecting member integrally formed at one side of the elastic base;
removing the elastic base together with the keytops, and the connecting members from the second mold, and
trimming the connecting member from the keytops to form an integral keypad.

6. The method as claimed in claim 5, wherein the keytops are made of a material selected from the group consisting of polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, and polypropylene.

7. The method as claimed in claim 5, wherein the elastic base is made of thermoplastic urethanes (TPU).

8. The method as claimed in claim 5, wherein each keytop has a groove defined in a bottom surface thereof, the elastic base has a plurality of protrusions formed at one side thereof, each protrusions engages in one respective groove.

9. The method as claimed in claim 5, wherein the first mold includes a first male mold and a first female mold, the second mold include a second female mold, the first male mold being rotatable or movable to selectively align with the first female mold and the second female mold.

10. The method as claimed in claim 9, wherein the second male mold further comprises a second male mold rotatable or removable to selectively align with the first and the second female molds.

11. The method as claimed in claim 9, wherein the step of forming the keytops includes the steps of: injecting molten plastic material into a first cavity defined by the first male mold and the first female mold; cooling the first male mold and the first female mold, with the keytops adhering to the first male mold together with the connecting members.

12. The method as claimed in claim 9, wherein the elastic base is integrally formed with the keytops by injecting elastic material into a second cavity defined by the first male mold and the second female mold.

13. An electronic device comprising:
a body having a display disposed thereon; and
a keypad disposed on the body, the keypad including;
an elastic base; and
a plurality of keytops, the keytops being integrally formed at one side of the elastic base.

14. The electronic device as claimed in claim 13, wherein the keytops are made of a material selected from the group consisting of polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, and polypropylene.

15. The electronic device as claimed in claim 13, wherein the elastic base is made of thermoplastic urethanes (TPU).

16. The electronic device as claimed in claim 13, wherein each keytop has a groove defined in a bottom surface thereof, the elastic base has a plurality of protrusions formed at one side thereof, each protrusions engages in the respective groove.
